(19) United States
(12) Patent Application Publication
(10) Pub. No.: US 2026/0169145 A1
(43) Pub. Date: Jun. 18, 2026

(54) VEHICULAR RADAR SENSING SYSTEM WITH NOISE CANCELLATION ELEMENT

(71) Applicant: Magna Electronics Inc., Auburn Hills, MI (US)

(72) Inventors: Walter Poiger, Bad Neustadt/S (DE); Holger Hess, Hösbach (DE)

(21) Appl. No.: 19/422,784

(22) Filed: Dec. 17, 2025

Related U.S. Application Data
(60) Provisional application No. 63/735,379, filed on Dec. 18, 2024.

(51) Int. Cl. G01S 13/04; G01S 7/35; G01S 7/40; G01S 13/931

(52) U.S. Cl. CPC G01S 13/04; G01S 7/354; G01S 7/4065; G01S 13/931; G01S 2013/93271

(57) ABSTRACT

A vehicular radar sensing system includes a radar sensor disposed at a vehicle equipped with the vehicular radar sensing system. The radar sensor includes a configurable delay element operable to delay a signal by a configurable amount. The configurable delay element adds a delay to a reference signal, and the delay is based on correlated noise including phase noise present in both the reference signal and the received radio signals. The vehicular radar sensing system mixes the delayed reference signal with radio signals received by a plurality of receivers of the radar sensor. The vehicular radar sensing system, via processing at a data processor of received radio signals mixed with the delayed reference signal, detects presence of an object.

### CROSS REFERENCE TO RELATED APPLICATION

The present application claims the filing benefits of U.S. provisional application Ser. No. 63/735,379, filed Dec. 18, 2024, which is hereby incorporated herein by reference in its entirety.

### FIELD OF THE INVENTION

The present invention relates generally to a vehicle sensing system for a vehicle and, more particularly, to a vehicle sensing system that utilizes one or more radar sensors at a vehicle.

### BACKGROUND OF THE INVENTION

Use of radar sensors in vehicle sensing systems is common and known. Examples of such known systems are described in U.S. Pat. Nos. 9,146,898; 8,027,029 and/or 8,013,780, which are hereby incorporated herein by reference in their entireties.

### SUMMARY OF THE INVENTION

A vehicular radar sensing system includes a radar sensor disposed at a vehicle equipped with the vehicular radar sensing system. The radar sensor senses interior or exterior of the vehicle. The radar sensor is operable to capture radar data. The radar sensor includes (i) a plurality of transmitters that transmit radio signals and (ii) a plurality of receivers that receive radio signals. The radar sensor includes a configurable delay element operable to delay a signal by a configurable amount. The system includes an electronic control unit (ECU) that includes electronic circuitry and associated software. Radar data captured by the radar sensor is transferred to the ECU. The electronic circuitry of the ECU includes a data processor. The ECU is operable to process radar data captured by the radar sensor and transferred to the ECU. The configurable delay element adds a delay to a reference signal, and the delay is based on correlated noise that includes phase noise present in both the reference signal and the received radio signals. The vehicular radar sensing system mixes the delayed reference signal with radio signals received by the plurality of receivers. The vehicular radar sensing system, via processing at the data processor of received radio signals mixed with the delayed reference signal, detects presence of an object.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a sensing system that incorporates a radar sensor;

FIG. 2 is a block diagram of a conventional vehicular radar system;

FIG. 3 is a block diagram that demonstrates direct coupling between a transmit antenna and a receive antenna;

FIG. 4 is a block diagram that demonstrates coupling through a radar housing;

FIG. 5 is a block diagram that demonstrates coupling through a secondary surface; and

FIGS. 6-9 are block diagrams of a vehicular radar sensor that includes an adjustable delay element to mitigate correlated noise.

### DESCRIPTION OF THE PREFERRED EMBODIMENTS

A vehicle sensing system and/or driver or driving assist system and/or object detection system and/or alert system operates to capture sensor data and process the captured sensor data to detect objects at or near the vehicle and in the predicted path of the vehicle, such as to assist a driver of the vehicle in maneuvering the vehicle in a rearward direction. The system includes a data processor or data processing system that is operable to receive sensor data from one or more sensors (e.g., radar sensors).

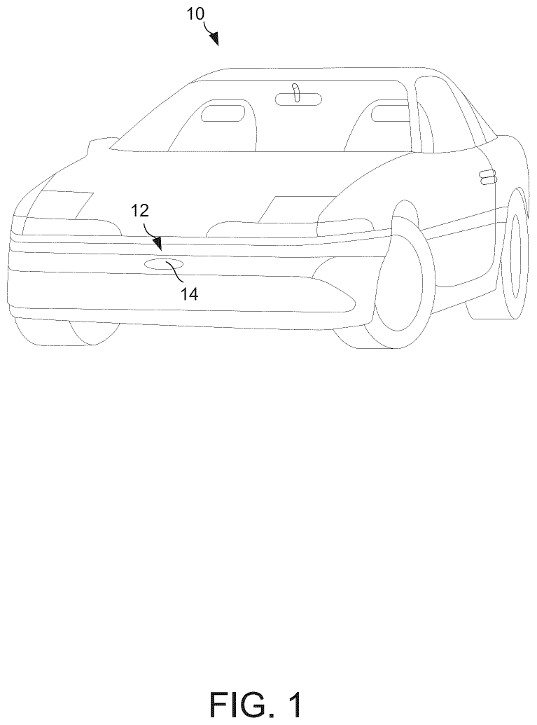

Referring now to the drawings and the illustrative embodiments depicted therein, a vehicle 10 (FIG. 1) includes a driving assistance system or sensing system 12 that includes at least one radar sensor unit, such as a forward facing radar sensor unit 14 (and the system may optionally include multiple exterior facing sensors, such as cameras, radar, or other sensors, such as a rearward facing sensor at the rear of the vehicle, and a sideward/rearward facing sensor at respective sides of the vehicle), which sense regions exterior of the vehicle. Optionally, the system may include an interior radar sensor that senses within an interior cabin of the vehicle, such as for occupant detection at one or more seats of the vehicle. The sensing system 12 includes a control or electronic control unit (ECU) that includes a data processor that is operable to process data captured by the radar sensor(s). The sensing system may also include a radar sensor that includes a plurality of transmitters that transmit radio signals via a plurality of antennas. The radar sensor also includes a plurality of receivers that receive radio signals via the plurality of antennas. The received radio signals are transmitted radio signals that are reflected from an object. The ECU or processor is operable to process the received radio signals to sense or detect the object that the received radio signals reflected from. The ECU or sensing system 12 may be part of a driving assist system of the vehicle, with the driving assist system controlling at least one function or feature of the vehicle (such as to provide autonomous driving control of the vehicle) responsive to processing of the data captured by the radar sensors. The data transfer or signal communication from the sensor to the ECU may comprise any suitable data or communication link, such as a vehicle network bus or the like of the equipped vehicle.

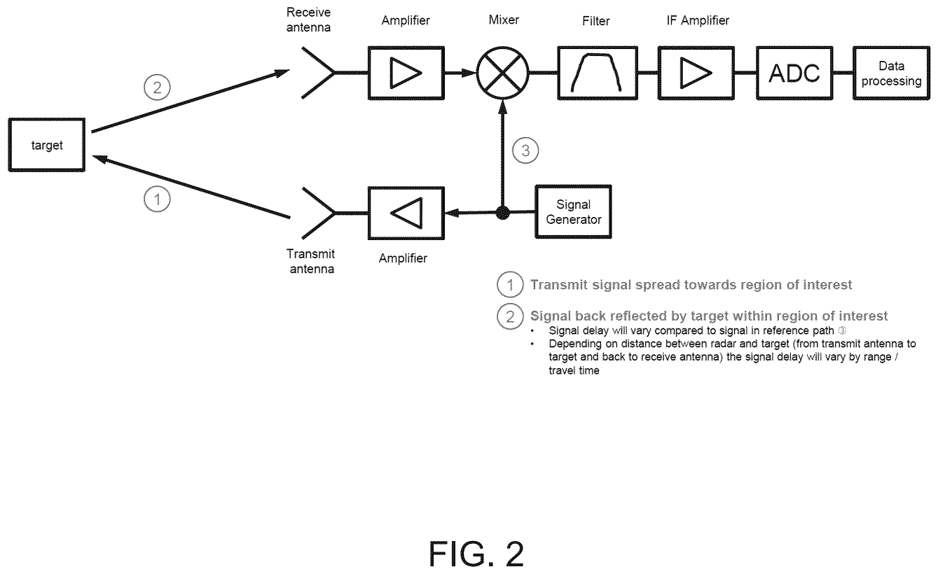

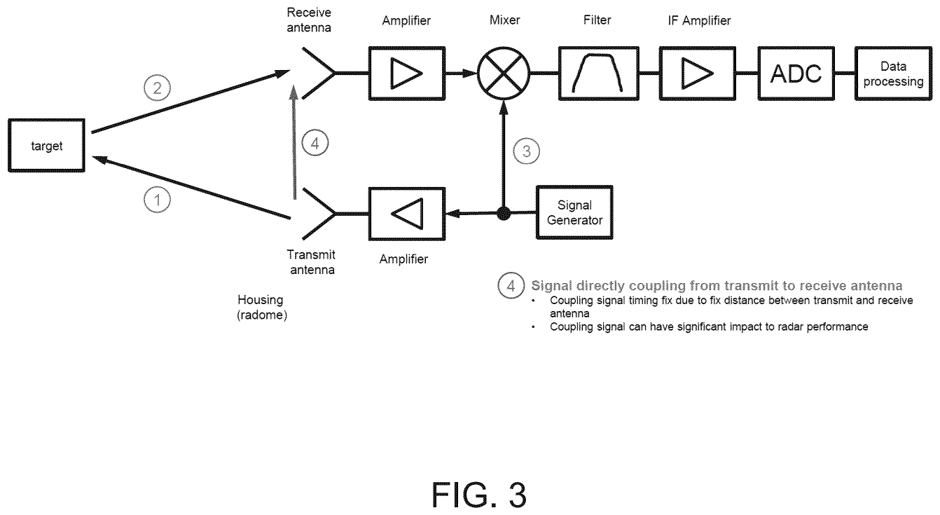

FIG. 2 illustrates a block diagram of an example automotive radar system. In some examples, the radar system operates as a frequency modulated continuous wave (FMCW) system, where a signal generator or oscillator generates a chirp signal that varies in frequency over time. Here, a transmit antenna transmits signals toward a region of interest at path 1. At path 2, the signal is reflected back by a target within the region of interest and captured by a receive antenna. The signal delay will vary relative to the signal in the reference path 3. That is, depending on the distance between the radar sensor and the target (i.e., the distance between the transmit antenna to the target and back to the receive antenna), the signal delay will vary by range or travel time. The mixer combines the received signal and the reference signal to generate an intermediate frequency (IF) signal or beat frequency that correlates to the range and/or velocity of the target. As shown in FIG. 3, radar systems are also prone to direct coupling where a coupling signal travels directly from the transmit antenna to the receive antenna. This direct coupling, which may be referred to as transmitter-to-receiver leakage or crosstalk, may occur through the substrate of the antenna circuit board or via side lobes of the respective antenna radiation patterns. The signal delay of this signal is dependent upon the distance between the transmit antenna and the receive antenna and may have a significant impact on the performance of the radar. For example, high-amplitude leakage signals may saturate the input stages of the receiver, such as a low noise amplifier (LNA) or an analog-to-digital converter (ADC), thereby desensitizing the receiver to weaker signals reflected from actual targets.

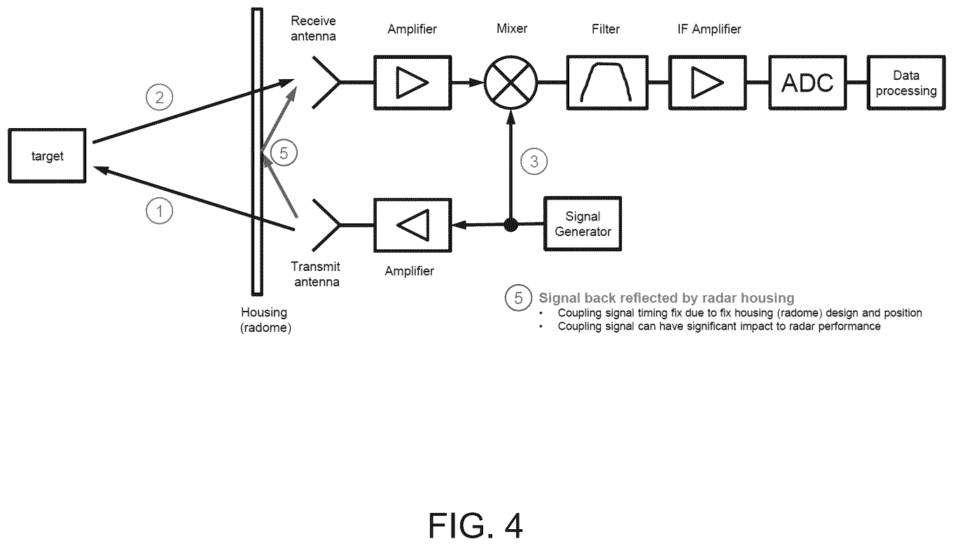

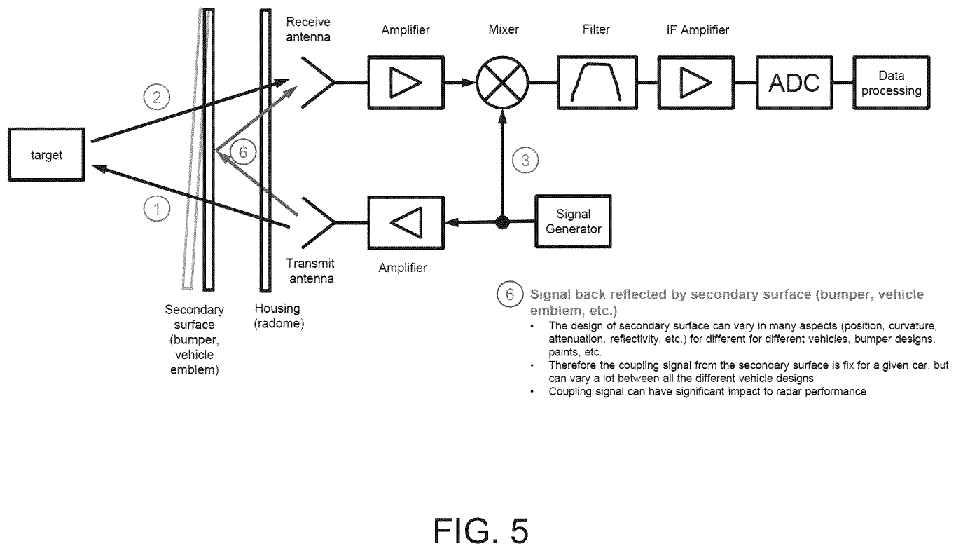

Similarly, and as shown in FIGS. 4 and 5, signals may couple through the radar housing or radome (FIG. 4) or a secondary surface (FIG. 5). In some implementations, the radar sensor is embedded within the vehicle structure such that the antenna array faces a material layer that is not perfectly transparent to radio frequency (RF) energy. These coupling signals are defined by the position and shape, size, curvature, reflectivity, etc., of the reflective surfaces. For example, a portion of the transmitted signal reflects off the radar housing or other surface and back to the receive antenna due to dielectric discontinuities or impedance mismatches at the boundary between the air and the material of the housing or surface. The secondary surface may be a bumper or an emblem or a panel (or an interior surface such as a headliner, interior trim panel, mirror casing, console cover, mirror reflective elements, etc.) or other surface of the vehicle beyond the radome. In occupant monitoring configurations, the close proximity of vehicle pillars, seat frames, or roof structures may create a complex near-field environment with multiple reflection points. In both scenarios, the coupling signal may have a significant impact on the performance of the radar. Because these surfaces are often located in the near-field of the radar sensor, the amplitude of the reflections may be magnitudes higher than reflections received from distant objects. For example, the coupling signal may interfere with the target signal and cause false detections, missed detections, or inaccurate measurements of the target.

The following example sinusoids may be used to illustrate the impact of coupling signals:

$${s}_{target} = sin ( ω \cdot t + {φ}_{target} )$$

$${s}_{coupling} = sin ( ω \cdot t + {φ}_{coupling} )$$

$${s}_{reference} = sin ( ω \cdot t + {ϕ}_{reference} )$$

All received signals (i.e., from target(s) as well as from different coupling sources) are mixed with the reference signal:

$$( {s}_{target} + {s}_{coupling} ) \cdot {s}_{reference} = {s}_{target} \cdot {s}_{reference} + {s}_{coupling} \cdot {s}_{reference}$$

The coupling related portion is described in more detail with the following equation:

$${s}_{coupling} \cdot {s}_{reference} = sin ( ω \cdot t + {φ}_{coupling} ) \cdot sin ( ω \cdot t + {φ}_{reference} )$$

Applying the sin product rule to the previous equation yields:

$$sin ( α ) \cdot sin ( β ) = \frac{1}{2} cos ( α - β ) - \frac{1}{2} cos ( α + β )$$

Next, the mixer output that includes coupling is represented by:

$${s}_{coupling} \cdot {s}_{reference} = \frac{1}{2} cos ( ω \cdot t + {φ}_{coupling} - ω \cdot t - {φ}_{reference} ) - \frac{1}{2} cos ( ω \cdot t + {φ}_{coupling} + ω \cdot t + {φ}_{reference} ) = \frac{1}{2} cos ( {φ}_{coupling} - {φ}_{reference} ) - \frac{1}{2} c o s ( 2 \cdot ω \cdot t + {φ}_{coupling} + {φ}_{reference} )$$

With the following filter device, the mixer output is reduced to:

$${filter}_{out} = \frac{1}{2} cos ( {φ}_{coupling} - {φ}_{reference} )$$

When it comes to signal noise, both phase terms are time dependent and different:

$${φ}_{coupling} ( t ) \neq {φ}_{reference} ( t )$$

In case of correlated noise, both phase terms are identical, but are constantly shifted in the time domain due to the different signal path lengths:

$${φ}_{coupling} ( t + Δ {t}_{coupling} ) = {φ}_{reference} ( t )$$

Therefore, the correlated noise is not canceled out as long as both mixer inputs fail to be synchronized in the time domain. Specifically, if the time delay of the leakage path differs significantly from the time delay of the reference path, the phase noise of the oscillator does not synchronize for cancellation. The correlated noise may degrade the signal to noise ratio and/or reduce the sensitivity and dynamic range of the radar system.

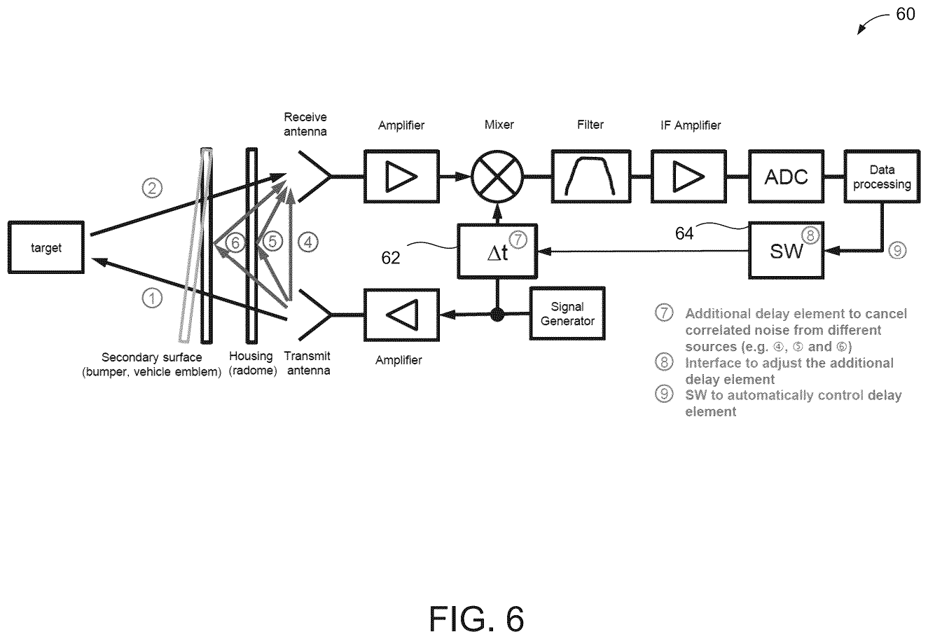

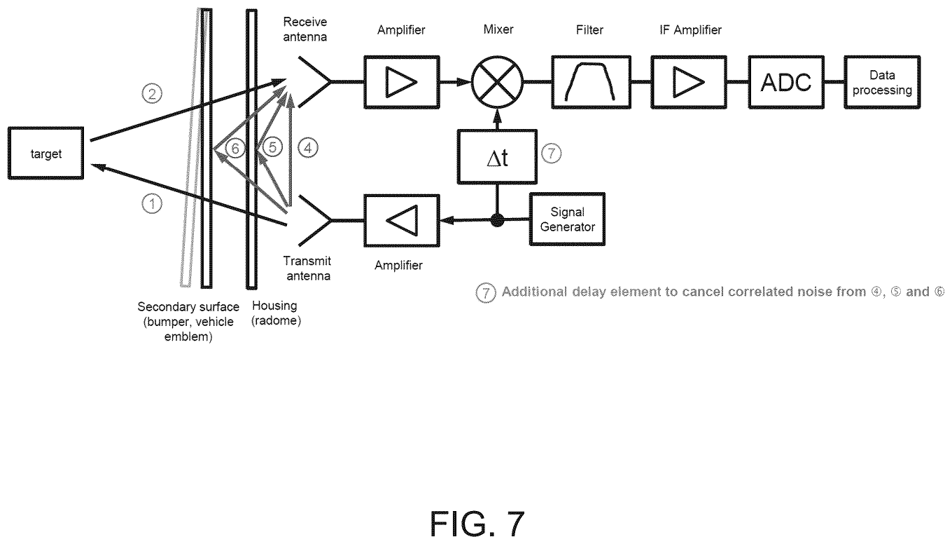

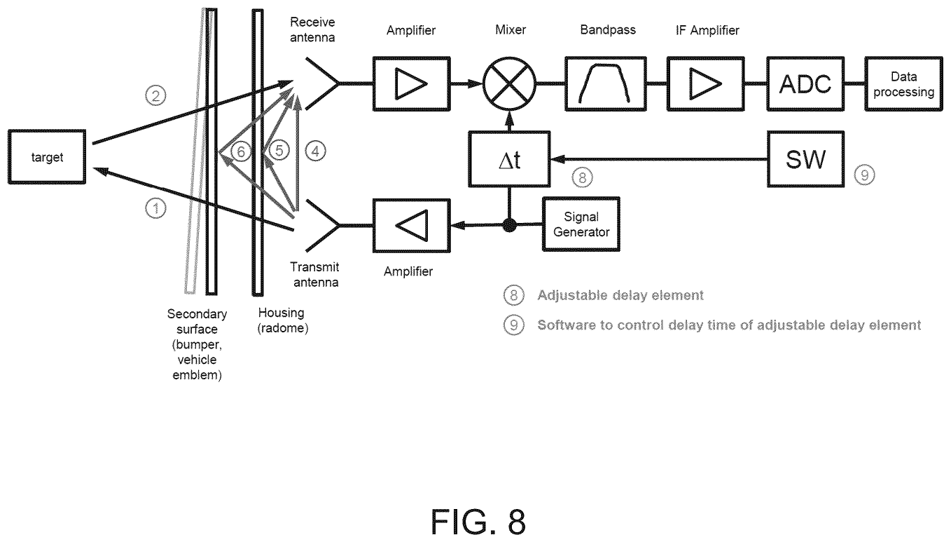

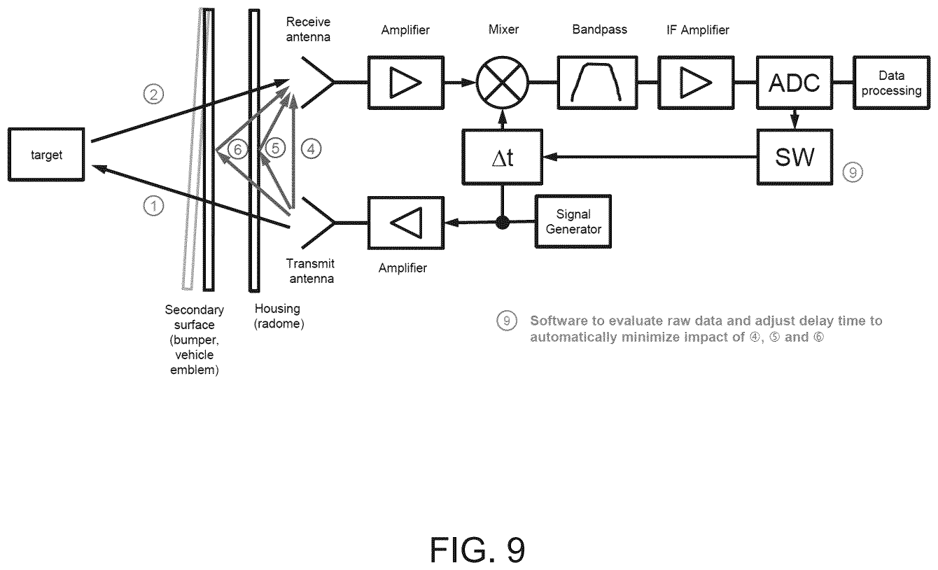

Referring now to FIGS. 6-9, a block diagram 60 includes the various coupling signal paths previously discussed (FIGS. 2-5). Coupling issues resulting from paths 4 and 5 may be solved by significant optimization work on the antenna, housing, and bandpass filter design. Coupling issues resulting from path 6 (i.e., the secondary surface) varies for all different vehicle designs, and thus may be challenging to correct during the sensor manufacturing stage because the specific geometry and material of the secondary surface (e.g., a bumper fascia) are not known until the sensor is integrated into the vehicle.

Advantageously, the block diagram 60 includes an adjustable delay element 62 to cancel out or mitigate the correlated noise from paths 4-6 (i.e., direct coupling, coupling through the radome, and coupling through the secondary surface). In some examples, the adjustable delay element 62 is disposed in the path of the local oscillator (LO) signal before the LO signal reaches the down-conversion mixer. The adjustable delay element may add an adjustable amount of delay to a signal generated by the signal generator and provided to a mixer. This added delay may compensate for the physical path length difference between the leakage path (e.g., the reflection from the bumper) and the internal reference path. The mixer mixes the delayed signal and the signal received by the receive antenna (and optionally amplified by an amplifier). For example, the mixer merges the delayed signal and the received signal in order to cancel out or mitigate or minimize the impact of the correlated noise (e.g., via subtraction or destructive interference) by aligning the phase of the phase noise components in the two signals such that the phase noise subtracts out during the mixing process.

Optionally, an interface (e.g., a software interface) is included to allow for adjustment of the delay element 62. For example, software 64 communicates with the delay element 62 to set or adjust the amount of delay that is added to the delayed signal. The system may also include software to automatically control the delay element. The software may generate digital control words or analog control voltages that drive the delay element 62 to a specific phase shift or time delay state. For example, a processor, an ECU, or other data processing element executes software that determines and/or sets the delay of the delay element.

The software 64 may provide a user interface, such as a graphical user interface, that allows a user, such as a technician, a manufacturer, or a driver, to manually adjust (i.e., predefine) the delay element 62 based on the vehicle specifications, the radar sensor characteristics, or the environmental conditions, such as during an end-of-line calibration process at a vehicle assembly plant. Alternatively or additionally, the software 64 may provide an automatic or adaptive adjustment of the delay element 62 based on the sensor data captured by the radar sensor or other sensors of the vehicle. For example, the software 64 may analyze the sensor data to determine the optimal delay value that minimizes the correlated noise and maximizes the target detection performance. In some implementations, the software 64 may sweep through a range of delay values while monitoring the noise floor in a specific range bin associated with the leakage, and select the delay value that results in the lowest amplitude for that range bin. The software 64 may also monitor the sensor data and adjust the delay element 62 dynamically in response to changes in the vehicle speed, direction, or position, or changes in the target characteristics or location, or changes in the ambient noise or interference, or changes in operating temperature that may cause expansion or contraction of the bumper or housing materials.

The delay element 62 is brought into the reference signal to synchronize the correlated/coherent noise in both signal paths:

$${φ}_{coupling} ( t + Δ {t}_{coupling} ) = {φ}_{reference} ( t + Δ {t}_{delay element} )$$

When synchronized, the filter output is constant, which signifies no noise:

$${filter}_{out} = \frac{1}{2} cos ( 0 )$$

The configurable or adjustable nature of the delay element 62 enables easy adaptations to different designs. In some examples, the delay element comprises a digitally programmable delay line, an analog phase shifter, or a switched transmission line structure that offers a plurality of discrete delay steps, thereby allowing a single radar sensor hardware configuration (e.g., a single stock keeping unit or SKU) to be deployed across multiple different vehicle platforms with varying physical integration constraints. For example, the delay may be adjusted based on the vehicle, the bumper, the radar housing, etc., as well as variations in paint thickness, material composition, or mounting brackets that affect the near-field reflection characteristics. The system may incorporate software to automatically control or adjust the delay element 62 by evaluating captured data (i.e., radar data captured by the receive antenna) to allow for automatic or dynamic adjustment of the delay element 62 based on the specifics of the equipped vehicle and/or current conditions. For example, the processor may perform a Fast Fourier Transform (FFT) on the received signals to identify a range bin associated with the housing or bumper reflection and iteratively adjust the delay element until the amplitude of the signal in that range bin is minimized.

Thus, the adjustable delay element 62 may provide a simple, effective, and low-cost solution to the problem of coupling noise in vehicular radar systems and methods. By mitigating noise in the electrical domain, the system and/or method reduces the need for expensive, high-tolerance mechanical shielding or specialized radar-transparent bumper materials. The adjustable delay element 62 may improve the reliability, accuracy, and safety of the vehicular sensing system and/or driver or driving assist system and/or object detection system and/or alert system and/or methods. Consequently, the reduction in the noise floor enhances the system's ability to detect vulnerable road users, such as pedestrians or cyclists, and reduces the likelihood of false positives in functions such as automatic emergency braking (AEB) or blind spot detection (BSD).

The system utilizes sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense within an interior cabin of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular radar sensing system, the vehicular radar sensing system comprising:
a radar sensor disposed at a vehicle equipped with the vehicular radar sensing system;
wherein the radar sensor is operable to capture radar data;
wherein the radar sensor comprises (i) a plurality of transmitters that transmit radio signals and (ii) a plurality of receivers that receive radio signals;
wherein the radar sensor comprises a configurable delay element operable to delay a signal by a configurable amount;
an electronic control unit (ECU) comprising electronic circuitry and associated software;
wherein radar data captured by the radar sensor is transferred to the ECU;
wherein the electronic circuitry of the ECU comprises a data processor;
wherein the ECU is operable to process radar data captured by the radar sensor and transferred to the ECU;
wherein the configurable delay element adds a delay to a reference signal, and wherein the delay is based on correlated noise comprising phase noise present in both the reference signal and the received radio signals;
wherein the vehicular radar sensing system mixes the delayed reference signal with radio signals received by the plurality of receivers; and
wherein the vehicular radar sensing system, via processing at the data processor of received radio signals mixed with the delayed reference signal, detects presence of an object.

2. The vehicular radar sensing system of claim 1, wherein the correlated noise is based on direct coupling between the plurality of transmitters and the plurality of receivers.

3. The vehicular radar sensing system of claim 1, wherein the correlated noise is based on reflections off a housing of the radar sensor.

4. The vehicular radar sensing system of claim 1, wherein the correlated noise is based on reflections of at least one selected from the group consisting of (i) a bumper of the vehicle, (ii) an emblem of the vehicle and (iii) a panel of the vehicle.

5. The vehicular radar sensing system of claim 1, wherein the vehicular radar sensing system determines the delay to minimize the correlated noise.

6. The vehicular radar sensing system of claim 5, wherein the vehicular radar sensing system determines the delay via processing at the data processor of the received radio signals.

7. The vehicular radar sensing system of claim 1, wherein the delay is predefined based on calibration of the radar sensor.

8. The vehicular radar sensing system of claim 1, wherein the delay is based on at least one selected from the group consisting of (i) a distance between the plurality of transmitters and the plurality of receivers, (ii) a distance between a housing of the radar sensor and the plurality of transmitters and (iii) a distance between a bumper of the vehicle and the plurality of transmitters.

9. The vehicular radar sensing system of claim 1, wherein mixing the delayed reference signal and the received radio signals cancels correlated noise present in both the delayed reference signal and the received radio signals.

10. The vehicular radar sensing system of claim 1, wherein the radar sensor senses exterior of the vehicle, and wherein the vehicular radar sensing system detects presence of the object for a driving assist system of the vehicle.

11. The vehicular radar sensing system of claim 1, wherein the radar sensor senses within an interior cabin of the vehicle, and wherein the vehicular radar sensing system detects presence of the object for an occupant detection system of the vehicle.

12. A method for sensing with a vehicular radar sensing system, the method comprising:
capturing radar data via a radar sensor disposed at a vehicle, wherein the radar sensor comprises (i) a plurality of transmitters that transmit radio signals and (ii) a plurality of receivers that receive radio signals;
adding, via a configurable delay element of the radar sensor, a delay to a reference signal, wherein the delay is based on correlated noise comprising phase noise present in both the reference signal and the received radio signals;
mixing the delayed reference signal with radio signals received by the plurality of receivers;
transferring radar data captured by the radar sensor to an electronic control unit (ECU) comprising electronic circuitry and associated software, wherein the electronic circuitry of the ECU comprises a data processor; and
detecting presence of an object via processing, at the data processor, of received radio signals mixed with the delayed reference signal.

13. The method of claim 12, wherein the correlated noise is based on direct coupling between the plurality of transmitters and the plurality of receivers.

14. The method of claim 12, wherein the correlated noise is based on reflections off a housing of the radar sensor.

15. The method of claim 12, wherein the correlated noise is based on reflections of at least one selected from the group consisting of (i) a bumper of the vehicle, (ii) an emblem of the vehicle and (iii) a panel of the vehicle.

16. The method of claim 12, further comprising determining the delay to minimize the correlated noise.

17. The method of claim 16, wherein determining the delay is performed via processing at the data processor of the received radio signals.

18. The method of claim 12, wherein the delay is predefined based on calibration of the radar sensor.

19. The method of claim 12, wherein the delay is based on at least one selected from the group consisting of (i) a distance between the plurality of transmitters and the plurality of receivers, (ii) a distance between a housing of the radar sensor and the plurality of transmitters and (iii) a distance between a bumper of the vehicle and the plurality of transmitters.

20. The method of claim 12, wherein mixing the delayed reference signal and the received radio signals cancels correlated noise present in both the delayed reference signal and the received radio signals.
